(19) United States
(12) Patent Application Publication
(10) Pub. No.: US 2024/0346943 A1
(43) Pub. Date: Oct. 17, 2024

(54) VR TRAINING PERFORMANCE MANAGEMENT DEVICE, VR TRAINING PERFORMANCE MANAGEMENT METHOD, AND RECORDING MEDIUM

(71) Applicant: NEC Corporation, Tokyo (JP)

(72) Inventors: Takashi NONAKA, Tokyo (JP); Kentaro Nishida, Tokyo (JP)

(73) Assignee: NEC Corporation, Tokyo (JP)

(21) Appl. No.: 18/749,685

(22) Filed: Jun. 21, 2024

(30) Foreign Application Priority Data
Feb. 23, 2023 (JP) 2023-103233

(51) Int. Cl. G09B 5/02; G06Q 40/08

(52) U.S. Cl. CPC G09B 5/02; G06Q 40/08

(57) ABSTRACT

In a VR training performance management device, a providing means provides a VR training content, and an acquisition means acquires VR training implementation information generated by performing VR training using the VR training content by a user. A generation means generates credential information based on the VR training implementation information. A storing means stores identification information of the user and the credential information in association with each other. An output means outputs the credential information. The VR training implementation information includes at least a number of times that the VR training is performed by the user, gaze information of the user, and operation information of the user.

### TECHNICAL FIELD

This disclosure relates to management of performance by VR training.

### BACKGROUND ART

Recently, services to provide training using VR (Virtual Reality) equipment are becoming popular. For example, Patent Document 1 proposes a work training device for increasing the work skill of workers more efficiently.
Patent Document 1: Japanese Patent Application Laid-Open under No. JP 2019-197165

### SUMMARY

In training using VR equipment, it is possible to accumulate gaze information, movement information, and the like of the trainee during the training. However, the examination of how to effectively use those information has not been advanced. Also, even by Patent Document 1, it is not always possible to effectively use the information acquired by VR equipment.

One object of the present disclosure is to provide a VR training performance management device for issuing credentials based on the information acquired by VR equipment.

According to an example aspect of the present invention, there is provided a VR training performance management device comprising:

a providing means configured to provide a VR training content;

an acquisition means configured to acquire VR training implementation information generated by performing VR training using the VR training content by a user;

a generation means configured to generate credential information based on the VR training implementation information;

a storing means configured to store identification information of the user and the credential information in association with each other; and

an output means configured to output the credential information,

wherein the VR training implementation information includes at least a number of times that the VR training is performed by the user, gaze information of the user, and operation information of the user.

According to another example aspect of the present invention, there is provided a VR training performance management method comprising:

providing a VR training content;

acquiring VR training implementation information generated by performing VR training using the VR training content by a user;

generating credential information based on the VR training implementation information;

storing identification information of the user and the credential information in association with each other in a storage; and

outputting the credential information,

wherein the VR training implementation information includes at least a number of times that the VR training is performed by the user, gaze information of the user, and operation information of the user.

According to still another example aspect of the present invention, there is provided a recording medium recording a program, the program causing a computer to execute processing of:

providing a VR training content;

acquiring VR training implementation information generated by performing VR training using the VR training content by a user;

generating credential information based on the VR training implementation information;

storing identification information of the user and the credential information in association with each other in a storage; and

outputting the credential information,

wherein the VR training implementation information includes at least a number of times that the VR training is performed by the user, gaze information of the user, and operation information of the user.

### Effect

According to the present disclosure, it is possible to issue credentials based on the information acquired by VR equipment.

### BRIEF DESCRIPTION OF THE DRAWINGS

FIG. 1 illustrates an entire configuration of a VR training performance management system according to a first example embodiment.

FIG. 2 is a block diagram showing a configuration of a server according to the first example embodiment.

FIG. 3 is a block diagram showing a functional configuration of the server according to the first example embodiment.

FIG. 4 is an example of a credential.

FIG. 5 a display example of a credential list.

FIGS. 6A and 6B are examples of a report.

FIG. 7 is a flowchart of credential generation processing according to the first example embodiment.

FIG. 8 is a flowchart of display data generation processing according to the first example embodiment.

FIG. 9 is a flowchart of display data generation processing according to the first example embodiment.

FIG. 10 is a block diagram showing a functional configuration of a VR training performance management device according to a second example embodiment.

FIG. 11 is a flowchart of processing by the VR training performance management device according to the second example embodiment.

### EXAMPLE EMBODIMENTS

Preferred example embodiments of the present disclosure will be described with reference to the accompanying drawings.

### First Example Embodiment

### [System Configuration]

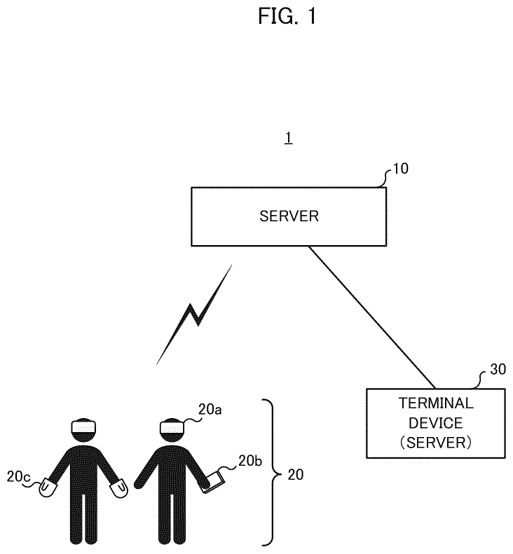

FIG. 1 shows an entire configuration of a VR training performance management system to which a VR training performance management device according to the present disclosure is applied. The VR training performance management system 1 includes a server 10, VR equipment 20 used by participants of VR training (hereinafter also referred to as a “user”), and a terminal device 30. The server 10 is an example of a VR training performance management device.

The server 10 and the VR equipment 20 can communicate in a wired or wireless manner, and the server 10 and the terminal device 30 can communicate in a wired or wireless manner. Incidentally, since there is multiple VR equipment 20, a subscript is added to the VR device 20 when distinguishing the individual VR equipment from each other, and they are simply referred to as “VR equipment 20” when they are not distinguished from each other. Further, it is assumed that there are multiple terminal devices 30.

The server 10 provides the user with a virtual training center. In the virtual training center, multiple VR training contents are prepared in advance. For example, the server 10 provides VR training contents, such as equipment operating training, equipment maintenance training, safety training, and in-house qualification testing, to employees working in the plant. The server 10 transmits the VR training contents to the VR equipment 20 when requested by the user.

The users perform the VR training using the VR equipment 20. The VR equipment 20 includes, for example, a VR goggle 20a, a remote controller 20b, a VR glove 20c. The VR equipment 20 receives the VR training contents from the server 10 and displays them on the VR goggle 20a. At this time, the VR goggle 20a displays a virtual space that faithfully reproduces the circumstance of the site. The user can perform the training on the virtual space by operating the remote controller 20b and/or the VR globe 20c.

The VR equipment 20 transmits VR training implementation information to the server 10. The VR training implementation information includes gaze information and operation information of the user, as well as a training time during the training. For example, the VR goggle 20a detects the movement of a user's line of sight using an eye-tracking function. Then, the VR goggle 20a transmits the detected movement of the line of sight to the server 10 as the gaze information. Also, the remote controller 20b is provided with operation buttons. The remote controller 20b transmits the operation of the buttons by the user to the server 10 as the operation information. Further, the VR globe 20c has a plurality of built-in sensors such as pressure-sensors, accelerometers, and gyro-sensors. The VR glove 20c transmits the movement of each part of the user's hand detected by the various sensors to the server 10 as the operation information.

The server 10 generates credentials based on the VR training implementation information received from the VR equipment 20 and the correct answer information of the VR training contents prepared in advance. The credentials are information to certify capabilities, skills, technologies and the like of the user. The credentials can be expressed by the proficiency of technology and knowledge, skill evaluation, qualification name, etc.

The terminal device 30 is a terminal device such as a server, a personal computer (PC), or a tablet. The user may request the server 10 to generate his or her own list of credentials via the terminal device 30. The server 10 generates a list of credentials in response to the generation request from the user and transmits the credential list to the terminal device 30. The user can use his or her own credential list for proving his or her skills to third parties.

### [Hardware Configuration]

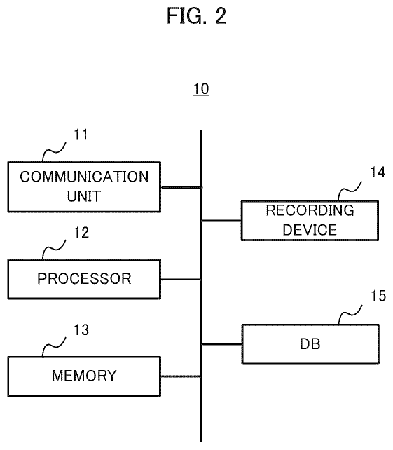

FIG. 2 is a block diagram illustrating a hardware configuration of the server 10. The server 10 mainly includes a communication unit 11, a processor 12, a memory 13, a recording device 14, and a data base (DB) 15.

The communication unit 11 transmits and receives data to and from external devices. Specifically, the communication unit 11 transmits and receives information to and from the VR equipment 20 and the terminal device 30.

The processor 12 is a computer such as a CPU (Central Processing Unit) and controls the entire server 10 by executing a program prepared in advance. Incidentally, as the processor 12, a CPU, a GPU (Graphics Processing Unit), a DSP (Digital Signal Processor), an MPU (Micro Processing Unit), an FPU (Floating Point number Processing Unit), a PPU (Physics Processing Unit), a TPU (Tensor Processing Unit), a quantum processor, a microcontroller, or a combination thereof can be used.

The memory 13 may be a ROM (Read Only Memory) and a RAM (Random Access Memory). The memory 13 temporarily stores various programs executed by the processor 12. The memory 13 is also used as a working memory during various processing performed by the processor 12.

The recording device 14 is a non-volatile and non-transitory recording device such as a disk-like recording medium, a semiconductor memory, or the like. The recording device 14 records various programs to be executed by the processor 12.

The recording device 14 also records information related to the user, information related to the VR training, and the like. In the recording device 14, as information related to the user, identification information for uniquely identifying the user (hereinafter referred to as “user ID”), attribute information of the user and the credentials acquired by the user are recorded in association with each other. The attribute information of the user includes, for example, gender, age, department to which the user belongs, years of service, history of taking VR training, history of taking other learning contents such as e-learning, etc. In addition, as the information related to the VR training, the recording device 14 records the identification information for uniquely identifying the VR training content (hereinafter, also referred to as “training ID”), the VR training content data, and the correct answer information of the VR training content, which will be described later, in association with each other.

The recording device 14 may be a storage device such as a removable flash memory. Instead of the recording device 14, the server 10 may be provided with an external storage device to store programs and data so that the server 10 can acquire the programs and data from the external storage device through communication.

The server 10 may include an input unit such as a keyboard and a mouse, and a display unit such as a liquid crystal display to allow an administrator to give instructions or input.

### Functional Configuration

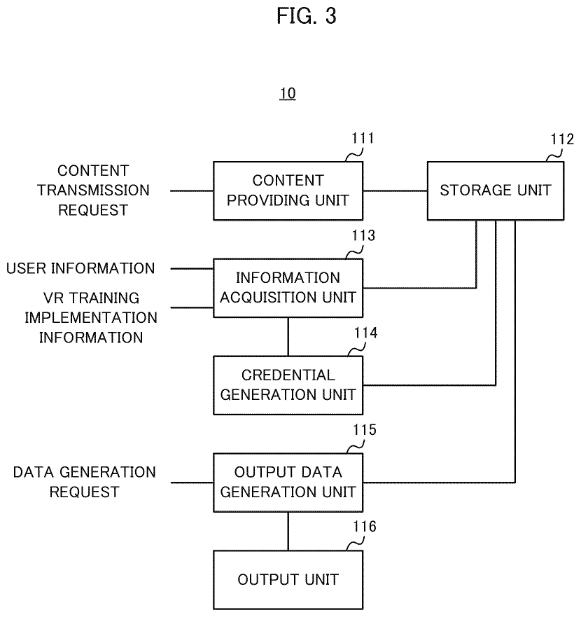

FIG. 3 is a block diagram showing a functional configuration of the server 10 according to the first example embodiment. The server 10 functionally includes a content providing unit 111, a storage unit 112, an information acquisition unit 113, a credential generation unit 114, an output data generation unit 115, and an output unit 116. The storage unit 112 is an example of the above-described recording device 14.

The server 10 receives a transmission request of the VR training content from the VR equipment 20. The transmission request includes a training ID and a user ID, for example. The transmission request is inputted to the content providing unit 111. The content providing unit 111 acquires the VR training content data associated with the training ID from the storage unit 112. Then, the content providing unit 111 transmits the VR training content data to the VR equipment 20 through the communication unit 11.

When the user completes the VR training, the VR equipment 20 transmits the user information and the VR training implementation information to the server 10. The user information includes the user ID and the attribute information of the user. The VR training implementation information includes the training ID in addition to the gaze information and operation information of the user during training, and the training time indicating the time that the VD training was performed by the user.

The server 10 receives the user information and the VR training implementation information from the VR equipment 20. The user information and the VR training implementation information are inputted to the information acquisition unit 113. The information acquisition unit 113 outputs the user information and the VR training implementation information to the credential generation unit 114.

The credential generation unit 114 acquires the correct answer information of the VR training content associated with the training ID from the storage unit 112. Then, the credential generation unit 114 generates the credential based on the correct answer information of the VR training content and the VR training implementation information. The credential generation unit 114 associates the user ID with the generated credential and stores them in the storage unit 112.

In response to a data generation request from the terminal device 30, the output data generation unit 115 generates display data, and outputs the display data to the output unit 116. Then, the output unit 116 transmits the display data to the terminal device 30.

Specifically, the user transmits the data generation request to the server 10 via the terminal device 30. For example, the data generation request includes the user ID and a request to generate a list of credentials (hereinafter also referred to as “credential list”) corresponding to the user ID. The server 10 receives the data generation request from the terminal device 30 through the communication unit 11. The data generation request is inputted to the output data generation unit 115. The output data generation unit 115 extracts the credentials associated with the user ID from the storage unit 112 and generates a credential list. The output data generation unit 115 outputs the generated credential list to the output unit 116. The output unit 116 transmits the credential list to the terminal device 30 via the communication unit 11.

In addition to the user, an employer or a manager may transmit the data generation request to the server 10 via the terminal device 30. In this case, the data generation request may include, for example, a condition for generating a report and/or a request for generating a report. When acquiring the data generation request, the output data generation unit 115 extracts corresponding data from the storage unit 112 based on the condition for generating the report, and generates a report. Thus, an employer or a manager can process the accumulated credentials into various forms and use them for analysis.

In the above-described configuration, the content providing unit 111 is an example of a providing means, the storage unit 112 is an example of a storing means, the information acquisition unit 113 is an example of an acquisition means, the credential generation unit 114 is an example of a generation means, and the output data generation unit 115 and the output unit 116 are an example of an output means.

### [Credential Generation Method]

Next, an example of a method of generating a credential by the credential generation unit 114 will be described. In the following explanation, the proficiency of the VR training is used as the credential.

(Method 1) Determine the proficiency using multiple evaluation items.

For example, it is assumed that a user performed a training of locking multiple facilities. The user locks the multiple facilities in the virtual space displayed on the VR goggle 20a by operating the remote controller 20b. At this time, the VR equipment 20 transmits the VR training implementation information including the gaze information of the user, the operation information of the remote controller, the training time, and the training ID to the server 10.

The credential generation unit 114 acquires the correct answer information of the VR training content associated with the training ID from the storage unit 112. The correct answer information of the VR training content includes multiple evaluation items in addition to the correct answer of the VR training content. Note that the multiple evaluation items include, for example, items such as attention, accuracy, and speed. Also, the correct answer includes information such as the positions of the locks, the order of locking, the standard time of training, etc. The credential generation unit 114 calculates the evaluation values of the multiple evaluation items based on the correct answers and the VR training implementation information.

Specifically, the credential generation unit 114 calculates the evaluation value of the attention based on the positions of the locks and the gaze information. For example, the credential generation unit 114 determines whether or not the line of sight of the user has stayed at the position of the lock for a predetermined time, i.e., whether or not the user has visually checked the position of the lock. Then, the credential generation unit 114 determines the evaluation value of attention based on the ratio of the number of locks that the user has visually checked, to the total number of the locks.

The credential generation unit 114 calculates the evaluation value of accuracy based on the order of locking and the operation information. For example, the credential generation unit 114 determines how much the order in which the user locked the multiple facilities coincides the order of the correct answer. Then, the credential generation unit 114 determines the evaluation value of accuracy based on the degree of coincidence.

The credential generation unit 114 calculates the evaluation value of the speed based on the standard time of the training and the actual training time of the user. For example, the credential generation unit 114 determines the evaluation value of the speed based on the difference between the standard time of the training and the actual training time by the user. The credential generation unit 114 may calculate the evaluation value of the speed based on the actual training time, the positions of the locks, and the operation information. For example, the credential generation unit 114 may determine the evaluation value of the speed based on the ratio of the number that the user has locked within a predetermined time, to the total number of the locks.

Then, the credential generation unit 114 determines the proficiency using the evaluation value of each evaluation item. For example, the credential generation unit 114 determines that the proficiency is “A” when the average of the evaluation values of the evaluation items is equal to or higher than a predetermined threshold TH1, that the proficiency is “B” when the average is lower than the predetermined threshold TH1 but equal to or higher than a predetermined threshold TH2, and that the proficiency is “C” when the average is lower than the predetermined threshold TH2. The credential generation unit 114 associates the proficiency with the user ID and stores them in the storage unit 112.

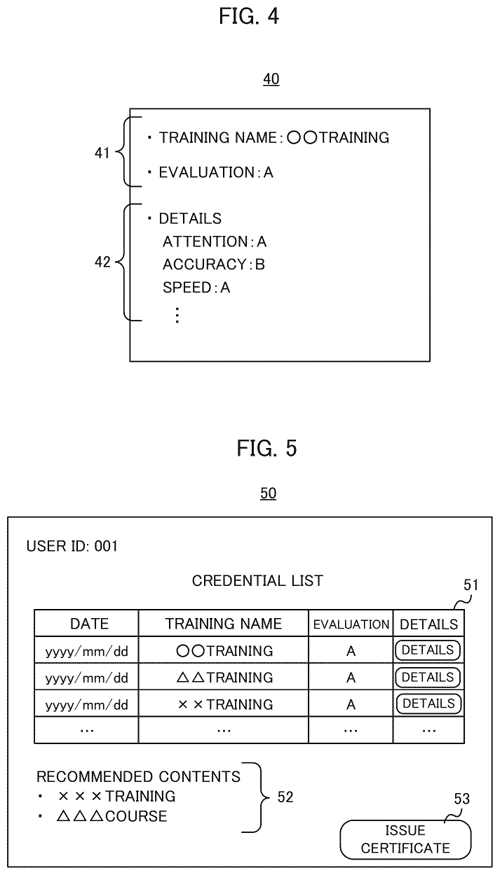

FIG. 4 is an example of credential. In the example of FIG. 4, the credential 40 include basic information 41 and detailed information 42. The basic information 41 indicates the training name and the comprehensive evaluation for the training. The comprehensive evaluation is determined based on the evaluation value of each evaluation item. The detailed information 42 indicates each evaluation item and its evaluation value. In FIG. 4, each of the evaluation items, i.e., attention, accuracy, and speed, is evaluated in three stages from A to C.

The credential generation unit 114 may use the attribution information of the user to generate the credential in addition to the VR training implementation information. For example, the credential generation unit 114 may determine the proficiency by weighting the respective evaluation items according to the user's department and years of continuous work, the course history of the VR training and the course history of e-learning. The credential generation unit 114 may also determine whether or not to generate the credential based on whether or not the number of times taking the same VR training is equal to or larger than a predetermined number of times.

The credential generation unit 114 may determine the proficiency by using a machine learning model that has learned the relation between the user's VR training implementation information and the proficiency.

(Method 2) Determine the proficiency by comparing the VR training implementation information of the user with the VR training implementation information of a skilled person.

For example, it is assumed that a user took the training of assembling the parts. Specifically, it is assumed that the user assembles a plurality of parts in the virtual space displayed on the VR goggle 20a by operating the VR glove 20c. At this time, the VR equipment 20 transmits the VR training implementation information including the gaze information of the user, the operation information of the VR glove, the training time, and the training ID to the server 10.

The credential generation unit 114 acquires the correct answer information of the VR training content associated with the training ID from the storage unit 112. The correct answer information for the VR training content includes the VR training implementation information for a veteran employee. The credential generation unit 114 compares the VR training implementation information of the user with the VR training implementation information of the veteran employee to determine the proficiency of the user.

Specifically, the credential generation unit 114 determines the proficiency of the user based on the degree of coincidence of the assembly order of the parts. The credential generation unit 114 identifies the order in which the veteran employee assembles the parts and the order in which the user assembled the parts, respectively, on the basis of the gaze information and the operation information of the veteran employee and the user. Then, the credential generation unit 114 determines the degree of coincidence between the assembly order of the parts by the veteran employee and the assembly order of the parts by the user. The credential generation unit 114 determines the proficiency of the user such that the proficiency of the user becomes higher as the degree of coincidence is higher.

Further, the credential generation unit 114 may determine the proficiency of the user based on the degree of similarity of the hand movements. The credential generation unit 114 identifies the hand movements of the veteran employee and the hand movements of the user, based on the operation information of the veteran employee and the user, and the training time. The hand movements include, for example, timing of the hand movements, the hand shape, the finger pressure, etc.

Then, the credential generation unit 114 calculates the degree of similarity between the hand movements of the user and the hand movements of the veteran employee. The credential generation unit 114 determines the proficiency of the user such that the proficiency of the user becomes higher as the degree of similarity is higher.

### DISPLAY EXAMPLE

### Display Example 1

FIG. 5 shows an example of displaying a credential list transmitted by the server 10. The credential list screen 50 includes a credential list 51, a recommended contents field 52, and a certificate issuance button 53. The credential list 51 is a list of the credentials obtained by the user in the past, and includes the date of the implementation, the training name, the evaluation and the details. The “date” is the date when the VR training was performed. If the same VR training was performed more than once, the date of the last VR training is displayed. The “training name” is the name of the VR training performed by the user. The “evaluation” is the comprehensive evaluation of the VR training performed. The users can also view the evaluation for each of the evaluation items of the VR training by clicking the buttons in the “Details” column. The recommended contents field 52 shows the VR training and e-learning recommended to the user. The server 10 determines the recommended contents based on, for example, the user's history of the VR training and the evaluation of the VR training. In addition, the user can issue a certificate to certify that the user has completed the VR training, by pressing the certificate issuance button 53.

### Display Example 2

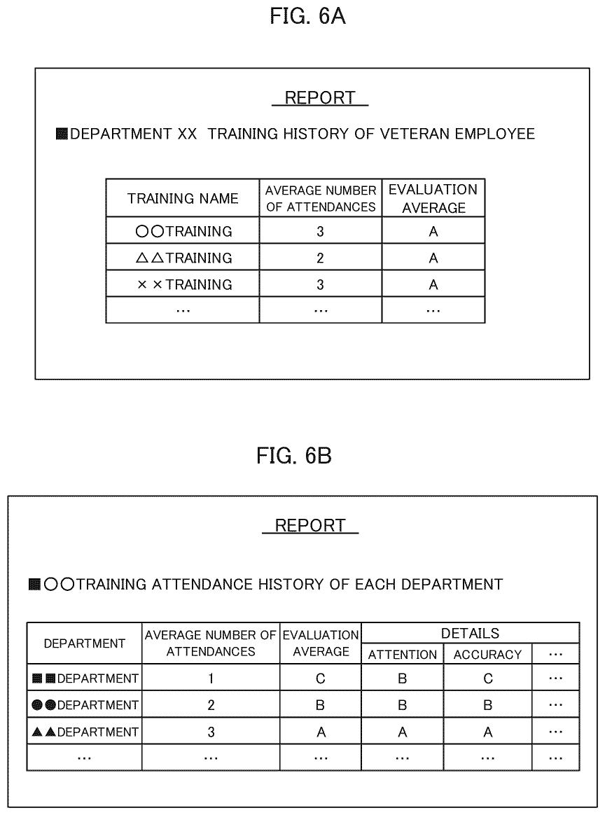

FIGS. 6A and 6B show examples of displaying a report transmitted by the server 10. FIG. 6A is a report on the training history of a veteran employee. The employer or the manager can display the reports as shown in FIG. 6A by designating the number of years of service, for example, as the report generation condition. This display enables the employer or the manager to grasp what kind of education should be given to young and mid-level employees. FIG. 6B is a report on the result of the VR training for each department. The employer or the manager can display a report as shown in FIG. 6B by designating the department name and/or the training name as the report generation condition. This display enables the employer or the manager to grasp the attendance status of the employees in the department to the VR training. The report generated by the server 10 is not limited to the above examples. The server 10 can generate various types of reports based on the report generation conditions entered by the employer or the manager.

### [Credential Generation Processing]

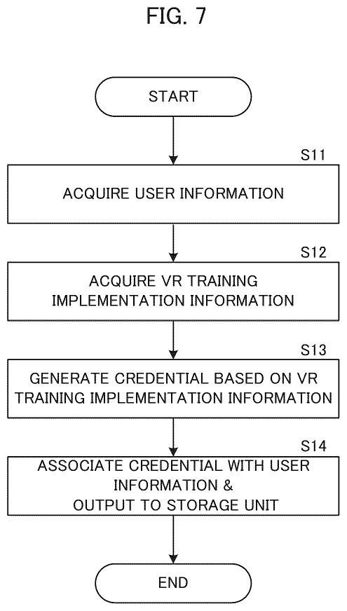

Next, the credential generation processing will be described. FIG. 7 is a flowchart of the credential generation processing performed by the server 10. This processing is realized by the processor 12 shown in FIG. 2, which executes a pre-prepared program and operates as each element shown in FIG. 3.

First, the server 10 receives the user information and the VR training implementation information from the VR equipment 20. The user information and the VR training implementation information are inputted to the information acquisition unit 113. The information acquisition unit 113 outputs the user information and the VR training implementation information to the credential generation unit 114 (steps S11, S12).

Next, the credential generation unit 114 generates the credential based on the VR training implementation information (step S13). Specifically, based on the training ID, the credential generation unit 114 acquires the correct answer information of the corresponding VR training content from the storage unit 112. Then, the credential generation unit 114 generates the credential based on the correct answer information of the VR training content and the VR training implementation information.

Next, the credential generation unit 114 associates the credential with the user information, and outputs them to the storage unit 112 (step S14). Then, the processing ends.

### [Display Data Generation Processing]

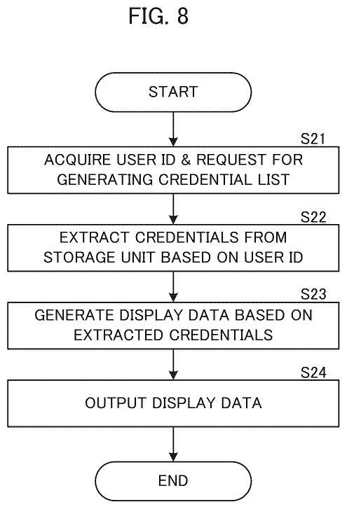

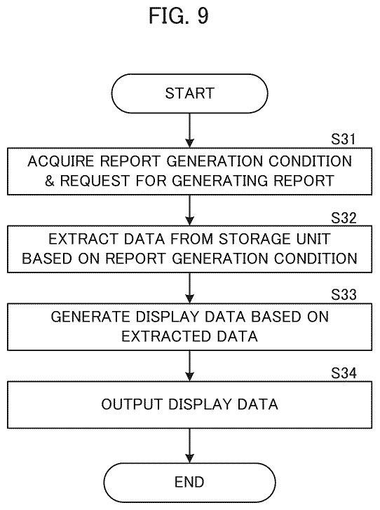

Next, the display data generation processing will be described. FIGS. 8 and 9 are flowcharts of the display data generation processing by the server 10. This processing is realized by the processor 12 shown in FIG. 2, which executes a pre-prepared program and operates as each element shown in FIG. 3.

FIG. 8 is a flowchart of the generation processing of the credential list. First, the server 10 receives the data generation request from the terminal device 30 through the communication unit 11 (step S21). The data generation request includes the user ID and the request for generating the credential list. Then, the data generation request is inputted to the output data generation unit 115.

Next, the output data generation unit 115 extracts the credentials associated with the user ID from the storage unit 112 (step S22). Next, the output data generation unit 115 generates display data of the credential list based on the extracted credentials, and outputs the display data to the output unit 116 (step S23). Next, the output unit 116 transmits the display data to the terminal device 30 (step S24). Then, the processing ends.

FIG. 9 is a flowchart of the report generation processing. First, the server 10 receives the data generation request from the terminal device 30 through the communication unit 11 (step S31). The data generation request includes the report generation condition and the request for generating the report. Then, the data generation request is inputted to the output data generation unit 115.

Next, the output data generation unit 115 extracts the corresponding data from the storage unit 112 on the basis of the report generation condition (step S32). Next, the output data generation unit 115 generates a report based on the extracted data, and outputs the display data of the report to the output unit 116 (step S33). Next, the output unit 116 transmits the display data to the terminal device 30 (step S34). Then, the processing ends.

### [Modifications]

To the first example embodiment described above, the following modifications may be applied. The following modifications can be applied in combination as required.

### (Modification 1)

The server 10 may provide incentives to those who find best practices in the VR training. For example, if a user accurately performed the VR training in a shorter time than the standard time, the server 10 determines that the VR training implementation information of that user is the best practice. Then, the server 10 grants the user higher credentials, by adding points to the evaluation value, for example. Also, the server 10 may update the correct answer information of the VR training content based on the best practice.

### (Modification 2)

The server 10 may send the credential acquisition status of the users to an insurance company. The insurance company can grasp the damage risk of the insurance contract by analyzing the credentials of the users and reflect it in the insurance fee and insurance money.

Incidentally, depending on the credential acquisition status of the users, the server 10 may calculate the insurance fee and transmit the calculated insurance fee to the insurance company. For example, the server 10 calculates insurance rates based on the number of participants in the VR training and the evaluation of the VR training. The server 10 determines that there is a higher risk of accident as the proportion of the participants in the VR training to the entire number of people covered by the insurance is lower or the evaluation of the VR training is lower, and sets the higher the insurance fee. The server 10 may calculate the insurance fee by using the attribute information of the users such as the number of years of continuous work, in addition to the credential acquisition status of the users.

The server 10 may calculate the insurance fee using a machine learning model which has learned the relationship of the credential information and the attribute information of the user with the insurance fee. In this case, the machine learning model calculates the insurance fee of each covered person by the insurance by inputting the credential information and the attribute information of the covered person. Then, the server 10 calculates the total value of the insurance fee of each covered person as the insurance fee to be presented to the customer, and transmits the insurance fee to the insurance company.

### (Modification 3)

The server 10 may issue credentials by NFT (Non-Fungible Token). The credentials issued in the form of NFT can work with other platforms, and therefore the credentials can be used in various situations such as finding employment.

### Second Example Embodiment

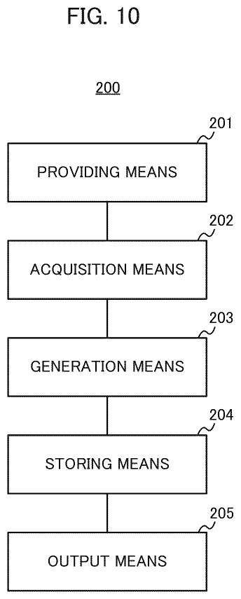

FIG. 10 is a block diagram illustrating a functional configuration of a VR training performance management device according to a second example embodiment. The VR training performance management device 200 includes a providing means 201, an acquisition means 202, a generation means 203, a storing means 204, and an output means 205.

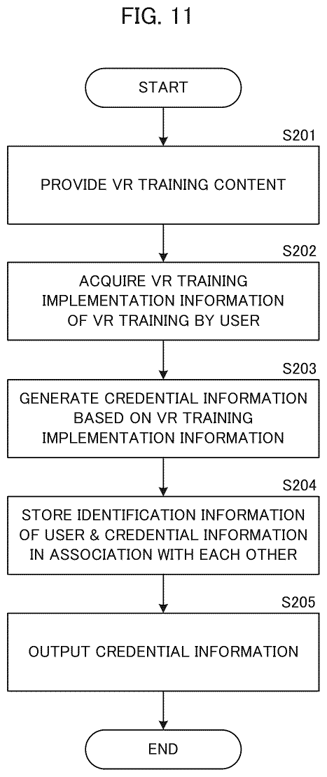

FIG. 11 is a flowchart of processing performed by the VR training performance management device according to the second example embodiment. The providing means 201 provides a VR training content (step S201). The acquisition means 202 acquires VR training implementation information generated by performing VR training using the VR training content by a user (step S202). The generation means 203 generates credential information based on the VR training implementation information (step S203). The storing means 204 stores identification information of the user and the credential information in association with each other (step S204). The output means 205 outputs the credential information. The VR training implementation information includes at least a number of times that the VR training is performed by the user, gaze information of the user, and operation information of the user.

According to the VR training performance management device 200 of the second example embodiment, the credential can be issued based on the information acquired by VR equipment.

A part or all of the example embodiments described above may also be described as the following supplementary notes, but not limited thereto.

### (Supplementary Note 1)

A VR training performance management device comprising:

a providing means configured to provide a VR training content;

an acquisition means configured to acquire VR training implementation information generated by performing VR training using the VR training content by a user;

a generation means configured to generate credential information based on the VR training implementation information;

a storing means configured to store identification information of the user and the credential information in association with each other; and

an output means configured to output the credential information,

wherein the VR training implementation information includes at least a number of times that the VR training is performed by the user, gaze information of the user, and operation information of the user.

### (Supplementary Note 2)

The VR training performance management device according to Supplementary note 1, wherein the output means outputs the credential information to an insurance company as information to be used in determining an insurance fee of the insurance company used by a company to which the user belongs.

### (Supplementary Note 3)

The VR training performance management device according to Supplementary note 1, further comprising an insurance fee determination means configured to determine the insurance fee,

wherein the acquisition means acquires attribute information of the user,

wherein the insurance fee determination means determines the insurance fee from the attribute information of the user and the credential information of the user using a machine learning model, which has learned relationship of the attribute information of the user and the credential information of the user with the insurance fee, and

wherein the output means outputs the insurance fee determined by the insurance fee determination means.

### (Supplementary Note 4)

The VR training performance management device according to Supplementary note 1, wherein the generation means acquires correct answer information corresponding to the VR training content, and generates the credential information based on a degree of coincidence between the correct answer information and the VR training implementation information.

### (Supplementary Note 5)

The VR training performance management device according to Supplementary note 4,

wherein the correct answer information includes multiple evaluation items,

wherein the generation means calculates evaluation value of each of the evaluation items based on the correct answer information and the VR training implementation information, and determines comprehensive evaluation based on the evaluation value of each of the evaluation items, and

wherein the output unit outputs the comprehensive evaluation and the evaluation value of each of the evaluation items as the credential information.

### (Supplementary Note 6)

The VR training performance management device according to Supplementary note 1,

wherein the generation means acquires the VR training implementation information of a skilled person for the VR training content, and determines technical proficiency of the user based on a degree of similarity between the VR training implementation information of the user and the VR training implementation information of the skilled person, and

wherein the output unit outputs the technical proficiency as the credential information.

### (Supplementary Note 7)

The VR training performance management device according to Supplementary note 4, further comprising a correct answer information updating means,

wherein the VR training implementation information includes a training time from a start to an end of the VR training,

wherein the correct answer information includes a standard training time,

wherein the generation means determines the VR training implementation information of the user to be a best practice when the user completes the VR training and the training time of the user is shorter than the standard training time, and

wherein the correct answer information updating means updates the correct answer information based on the best practice.

### (Supplementary Note 8)

A VR training performance management method comprising:

providing a VR training content;

acquiring VR training implementation information generated by performing VR training using the VR training content by a user;

generating credential information based on the VR training implementation information;

storing identification information of the user and the credential information in association with each other in a storage; and

outputting the credential information,

wherein the VR training implementation information includes at least a number of times that the VR training is performed by the user, gaze information of the user, and operation information of the user.

### (Supplementary Note 9)

A recording medium recording a program, the program causing a computer to execute processing of:

providing a VR training content;

acquiring VR training implementation information generated by performing VR training using the VR training content by a user;

generating credential information based on the VR training implementation information;

storing identification information of the user and the credential information in association with each other in a storage; and

outputting the credential information,

wherein the VR training implementation information includes at least a number of times that the VR training is performed by the user, gaze information of the user, and operation information of the user.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2023-103233, filed on Jun. 23, 2023, the disclosure of which is incorporated herein in its entirety by reference.

### DESCRIPTION OF SYMBOLS

1 VR training performance management system
10 Server
20 VR equipment
30 Terminal device
111 Content providing unit
112 Storage unit
113 Information acquisition unit
114 Credential generation unit
115 Output data generation unit
116 Output unit

1. A VR training performance management device comprising:
a memory configured to store instructions; and
a processor configured to execute the instructions to:
provide a VR training content;
acquire VR training implementation information generated by performing VR training using the VR training content by a user;
generate credential information based on the VR training implementation information;
store identification information of the user and the credential information in association with each other; and
output the credential information,
wherein the VR training implementation information includes at least a number of times that the VR training is performed by the user, gaze information of the user, and operation information of the user.

2. The VR training performance management device according to claim 1, wherein the processor outputs the credential information to an insurance company as information to be used in determining an insurance fee of the insurance company used by a company to which the user belongs.

3. The VR training performance management device according to claim 1,
wherein the processor is further configured to execute the instructions to determine the insurance fee,
wherein the processor acquires attribute information of the user,
wherein the processor determines the insurance fee from the attribute information of the user and the credential information of the user using a machine learning model, which has learned relationship of the attribute information of the user and the credential information of the user with the insurance fee, and
wherein the processor the insurance fee determined.

4. The VR training performance management device according to claim 1, wherein the processor acquires correct answer information corresponding to the VR training content, and generates the credential information based on a degree of coincidence between the correct answer information and the VR training implementation information.

5. The VR training performance management device according to claim 4,
wherein the correct answer information includes multiple evaluation items,
wherein the processor calculates evaluation value of each of the evaluation items based on the correct answer information and the VR training implementation information, and determines comprehensive evaluation based on the evaluation value of each of the evaluation items, and
wherein the output unit outputs the comprehensive evaluation and the evaluation value of each of the evaluation items as the credential information.

6. The VR training performance management device according to claim 1,
wherein the processor acquires the VR training implementation information of a skilled person for the VR training content, and determines technical proficiency of the user based on a degree of similarity between the VR training implementation information of the user and the VR training implementation information of the skilled person, and
wherein the processor outputs the technical proficiency as the credential information.

7. The VR training performance management device according to claim 4,
wherein the processor is further configured to execute the instructions to update the correct answer information,
wherein the VR training implementation information includes a training time from a start to an end of the VR training,
wherein the correct answer information includes a standard training time,
wherein the processor determines the VR training implementation information of the user to be a best practice when the user completes the VR training and the training time of the user is shorter than the standard training time, and
wherein the processor updates the correct answer information based on the best practice.

8. A VR training performance management method comprising:
providing a VR training content;
acquiring VR training implementation information generated by performing VR training using the VR training content by a user;
generating credential information based on the VR training implementation information;
storing identification information of the user and the credential information in association with each other in a storage; and
outputting the credential information,
wherein the VR training implementation information includes at least a number of times that the VR training is performed by the user, gaze information of the user, and operation information of the user.

9. A non-transitory computer-readable recording medium recording a program, the program causing a computer to execute processing of:
providing a VR training content;
acquiring VR training implementation information generated by performing VR training using the VR training content by a user;
generating credential information based on the VR training implementation information;
storing identification information of the user and the credential information in association with each other in a storage; and
outputting the credential information,
wherein the VR training implementation information includes at least a number of times that the VR training is performed by the user, gaze information of the user, and operation information of the user.
